(19) United States
(12) Patent Application Publication
(10) Pub. No.: US 2004/0140812 A1
(43) Pub. Date: Jul. 22, 2004

(54) Arrangements containing electrical assemblies and methods of cleaning such electrical assemblies

(76) Inventors: Ademir Scallante, Sertazoinho (BR); Geraldo Gullo, Sertazoinho (BR); Evaristo Orellana Alves, Sertazoinho (BR); Clovis Catananti Junior, Sertazoinho (BR)

Correspondence Address: BAKER & BOTTS, 30 ROCKEFELLER PLAZA, NEW YORK, NY, 10112

(21) Appl. No.: 10/348,436

(22) Filed: Jan. 21, 2003

(51) Int. Cl. G01N 27/02

(52) U.S. Cl. 324/444

(57) ABSTRACT

An arrangement containing an electrical assembly and a method for cleaning the electrical assembly are provided. In particular, a first portion of the arrangement may be connected to a wall of an enclosure, and a second portion of the arrangement extends from the first portion. In one exemplary embodiment of the present invention, the second portion is adapted to contain the electrical assembly, and when a fluid is dispensed from a position above the arrangement, the fluid contacts substantially the entire second portion in order to clean the electrical assembly. In another exemplary embodiment of the present invention, a housing of the arrangement is connected to the second portion, and the housing and/or the second portion is adapted to contain the electrical assembly. Moreover, when the fluid is dispensed from a position above the arrangement, the fluid contacts substantially the entire housing and/or the entire second portion in order to clean the electrical assembly.

### FIELD OF THE INVENTION

The present invention relates generally to arrangements containing an electrical assembly, such as a sensor assembly, and methods of cleaning such electrical assemblies. Specifically, the present invention is directed to an arrangement which includes an electrical assembly, and is connected to a wall of an enclosure such that the electrical assembly can be cleaned by dispensing a fluid from above the arrangement without removing the arrangement from the enclosure, as well as to a method for leaving such electrical assembly.

### BACKGROUND OF THE INVENTION

Conventional electrical assemblies, (e.g., sensor assemblies) may be used to determine a characteristic of a sample fluid within an enclosure (e.g., within a tank). For example, as described in U.S. Pat. No. 5,827,963, the entire disclosure of which is incorporated herein by reference, the sensor assemblies can be used to determine a temperature and density of the sample fluid, a pressure associated with the sample fluid, etc. Such sensor assembly may be connected to a side wall of the enclosure, and can be contained within a housing of a tank.

After this exemplary sensor assembly has been used for a particular period of time, it may be desirable to clean and/or disinfect the sensor assembly with a cleaning/disinfecting fluid. For such exemplary conventional sensor assembly, the sample fluid is generally removed from the enclosure, and the sensor assembly is generally detached from the side wall of the enclosure. After the sensor assembly is detached from the side wall of the enclosure, such sensor assembly can be cleaned and/or disinfected, and then may be reattached to the side wall of the enclosure. In addition, it may be necessary to clean the enclosure itself. Previously, that has been effectuated by removing the sensor assembly from the enclosure, cleaning such enclosure and then reattaching this sensor assembly. Nevertheless, removing the sensor assembly from the side wall of the enclosure and then reattaching the sensor assembly to such side wall can be difficult and time consuming.

For another conventional sensor assembly, a cleaning assembly can be formed integral with such sensor assembly, i.e., the sensor assembly and the cleaning assembly both can be contained within the housing. The cleaning assembly may be adapted to apply a cleaning fluid to the sensor assembly after the sample fluid has been removed from the enclosure. However, because the conventional sensor assembly and the cleaning assembly are both contained within the housing, when the cleaning assembly requires repair, both the cleaning assembly and the conventional sensor assembly must be removed from the tank regardless of whether the sensor assembly also requires repair. Moreover, since this conventional sensor assembly is formed integral with the cleaning assembly, when the cleaning assembly requires replacement, the sensor assembly must also be replaced regardless of whether such conventional sensor assembly requires replacement.

### SUMMARY OF THE INVENTION

Therefore, a need has arisen to provide an arrangement containing an electrical assembly, and methods of cleaning such electrical assembly, which overcome the above-described and other shortcomings of the prior art.

One of the advantages of the present invention is that the arrangement can contain the electrical assembly, and the electrical assembly can be cleaned using the method of the present invention without removing the arrangement from the wall of the enclosure. For example, a cleaning assembly can be connected to the side wall and positioned above the arrangement, and the cleaning assembly can be adapted to dispense a cleaning fluid. Moreover, the arrangement can be shaped such that when the fluid is dispensed from the cleaning assembly, the fluid contacts substantially the entire portion of the arrangement which contains the electrical assembly, and cleans the electrical assembly without removing the arrangement from the wall of the enclosure.

This and other advantages can be achieved with an exemplary embodiment of the arrangement and method according to the present invention. This arrangement containing the electrical assembly (e.g., a sensor assembly which includes one or more sensors), and the method for cleaning the electrical assembly, are provided for at least such purpose, as well as for other purposes according to the present invention. In particular, a first portion of the arrangement may be connected to a wall of an enclosure, and a second portion of the arrangement can extend from the first portion. In one exemplary embodiment of the present invention, the second portion may be adapted to contain the electrical assembly. When a fluid is dispensed from above the arrangement, the fluid contacts substantially the entire second portion in order to clean the electrical assembly.

For example, the fluid can be dispensed from a cleaning assembly connected to the wall of the enclosure, and positioned above the arrangement. In a variation of this exemplary embodiment of the present invention, a housing (e.g., a sensor housing) of the arrangement may be connected to the second portion, and the housing and/or the second portion can be adapted to contain the electrical assembly. Moreover, when the fluid is dispensed from a position that is above the arrangement, the fluid contacts substantially the entire housing and/or the entire second portion so as to clean the electrical assembly.

According to another exemplary embodiment of the present invention, the first portion may have a curved shape (e.g., a conical shape), and the second portion may be substantially cylindrical. Further, a particular vertical plane of the first portion can be substantially perpendicular to a horizontal plane of the second portion. In addition, the horizontal plane may be substantially perpendicular to a further vertical plane of the housing, such that the particular vertical plane may be parallel to the further vertical plane. Moreover, the arrangement can be shaped such that when the water is dispensed from the cleaning assembly, a first fluid portion contacts the first portion, the second portion and the housing, with a second fluid portion only contacting the first portion and the housing.

### BRIEF DESCRIPTION OF THE DRAWINGS

FIG. 1 is a schematic diagram of a first exemplary embodiment of an arrangement containing an electrical assembly according to the present invention.

FIG. 2 is an enlarged, partial schematic diagram of the arrangement of FIG. 1.

FIG. 3 is a schematic diagram of a second exemplary embodiment of the arrangement containing the electrical assembly according to the present invention.

FIG. 4 is a flow diagram of a first exemplary embodiment of a method according to the present invention for cleaning the arrangement containing the electrical assembly.

FIG. 5 is a flow diagram of a second exemplary embodiment of the method according to the present invention for cleaning the arrangement containing the electrical assembly.

### DETAILED DESCRIPTION

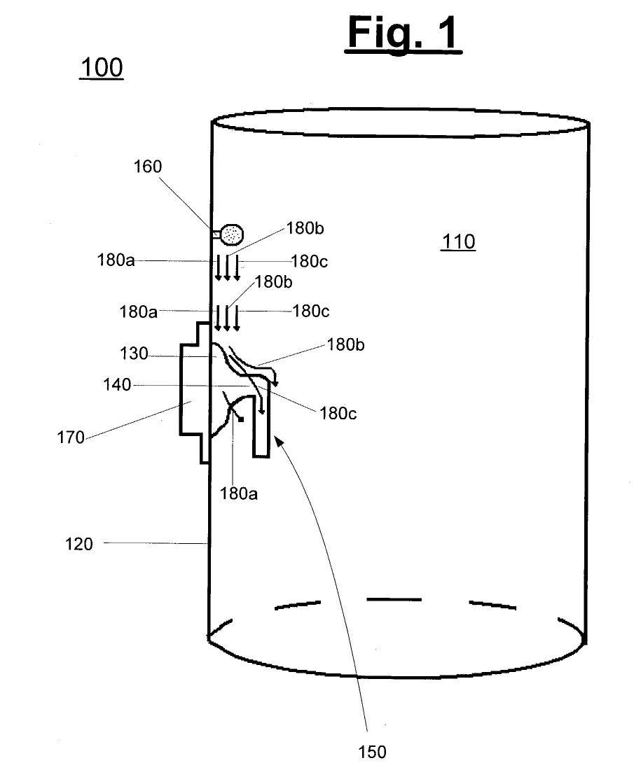

Exemplary embodiments of the present invention and their advantages may be understood by referring to FIGS. 1-5, like numerals being used for like corresponding parts in the various drawings.

Referring to FIG. 1, a first exemplary embodiment of an arrangement 100 containing an electrical assembly (not shown) is provided. In an exemplary embodiment of the present invention, the electrical assembly can be a sensor assembly which includes one or more sensors (not shown). For example, the sensor assembly described herein can be similar to the sensor assembly described in U.S. Pat. No. 5,827,963, the entire disclosure of which is incorporated herein by reference in its entirety. The arrangement 100 may include a first portion 130, a second portion 140 extending from the first portion 130, and a housing 150 (e.g., a sensor housing) connected to the second portion 140. For example, the first portion 130 can be connected to (e.g., affixed to) to a wall 120 (e.g., a side wall) of an enclosure 110 (e.g., a tank) by a connector assembly 170 positioned outside of the enclosure 110. For example, the connector assembly 170 may be similar to the connector assembly described in U.S. Pat. No. 5,827,963, the entire disclosure of which is incorporated herein by reference in its entirety., Moreover, the electrical assembly can be contained within the housing 150 and/or in the second portion 140.

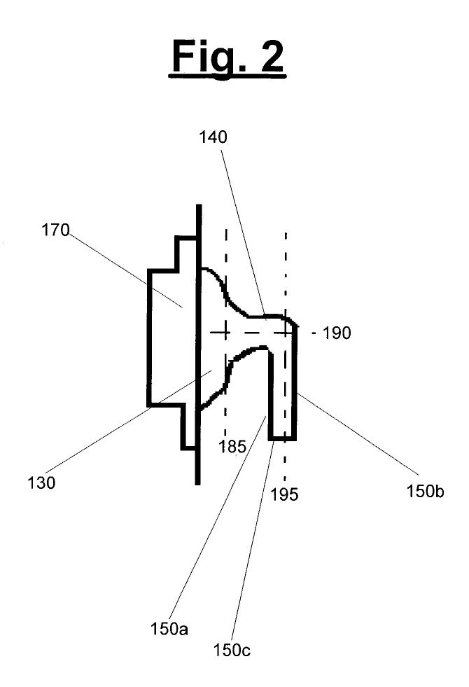

In an exemplary embodiment of the present invention, the first portion 130 may have a curved shape (e.g., a substantially conical shape), and the second portion 140 may have a substantially cylindrical shape. In this manner, fluid which contacts the second portion 140 can readily flow along the sides of such second portion 140. Moreover, the housing 150 may be connected to (and positioned below) the second portion 140. For example, as shown in FIG. 2, a particular vertical plane 185 of the first portion 130 can be substantially perpendicular to a horizontal plane 190 of the second portion 140, and such horizontal plane 190 may be substantially perpendicular to a further vertical plane 195 of the housing 150. In addition, the particular vertical plane 185 may be parallel to the further vertical plane 190.

Referring again to FIG. 1, according to an exemplary embodiment of the present invention, the arrangement 100 can also include a cleaning assembly 160. Such cleaning assembly 160 can be connected (e.g., affixed) to the wall 120 of the enclosure 110. In particular, the cleaning assembly 160 may be positioned above the first portion 130, the second portion 140 and the housing 150. The cleaning assembly 160 may be adapted to dispense fluid 180 (e.g., fluid which can include water) onto the first portion 130, the second portion 140 and the housing 150. Specifically, the fluid 180 may include a first fluid portion 180a, a second fluid portion 180b, and a third fluid portion 180c. Although the fluid 180 is discussed herein with respect to three fluid portions, it will be readily understood by those of ordinary skill in the art that the fluid 180 can include an infinite or large number of the fluid portions.

During an exemplary operation, when the cleaning assembly 160 dispenses the fluid 180, the first fluid portion 180a may contact the wall 120, and flow substantially along such wall 120. Moreover, the second fluid portion 180b and the third fluid portion 180c may flow adjacent to the wall 120. When the fluid 180 reaches the first portion 130, the second portion 140 and the housing 150, the first fluid portion 180a may contact (e.g., flow over) the first portion 130. For example, the first fluid portion 180a can flow substantially along the first portion 130, and the shape of the first portion 130 can direct the first fluid portion 180a towards a first side 150a (FIG. 2) of the housing 150 which is closest to the wall 120. Further, the second fluid portion 180b may contact (e.g., flow over) the second portion 140, and the shape of the second portion 140 can direct the second fluid portion 180c towards a second side 150b (FIG. 2) of the housing 150 which is furthest from the wall 120. In this manner, the second fluid portion 180c flows along the second side 150b. Moreover, the third fluid portion 180c may contact the first portion 130 and/or the second portion 140. The third fluid portion 180c may initially flow along the sides of the second portion 140, and then may flow along a pair of third sides 150b of the housing 150 which are adjacent to the first side 150a and the second side 150c. The third fluid portion 180c can also flow along the first portion 130, and contact (e.g., flow over) the first side 150a. Consequently, the entire fluid 180 can contact or flow over substantially the entire housing 150 (e.g., by contacting all four sides of the housing 150) in order to clean the electrical assembly without removing the arrangement 100 from the wall 120.

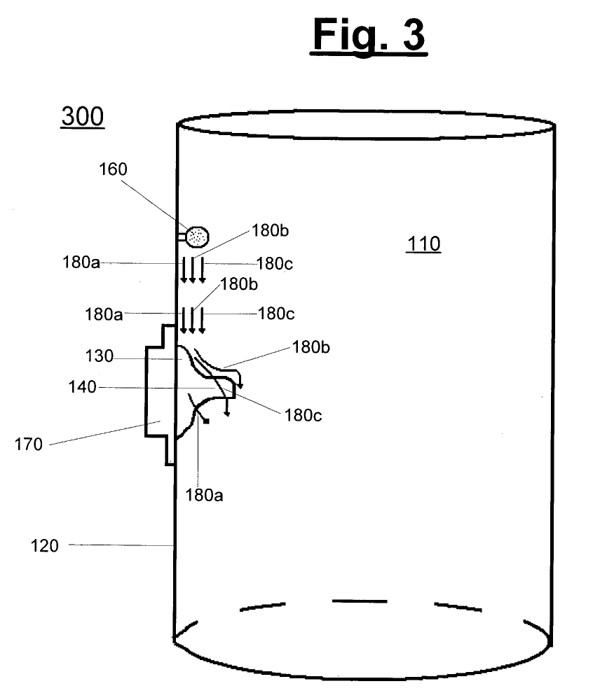

FIG. 3 shows a second exemplary embodiment of an arrangement 300 containing the electrical assembly (not shown). The features and advantages of the second exemplary embodiment of the present invention are substantially similar to (or same as) the features and advantages of the first exemplary embodiment of the present invention. Therefore, the features and advantages of the first exemplary embodiment of the present invention are not further discussed with respect to the second exemplary embodiment of the present invention. In addition, for this exemplary second embodiment of the present invention, the housing 150 can be removed, and the second portion 140 contains the electrical assembly. Moreover, the fluid 180 contacts or flows over substantially the entire second portion 140 so as to clean the electrical assembly without removing the arrangement 300 from the wall 120.

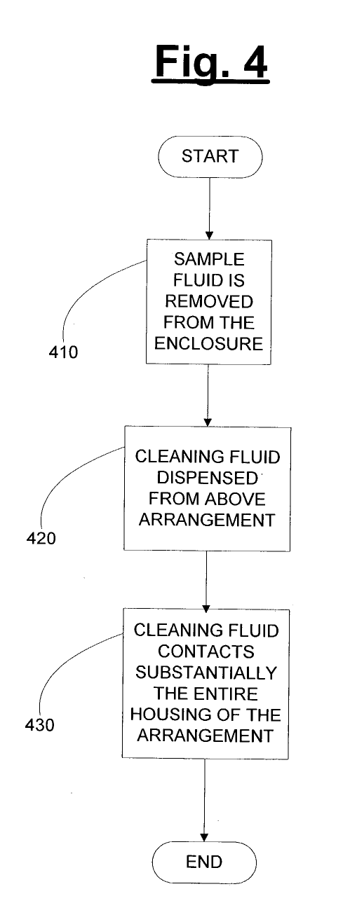

FIG. 4 shows a first exemplary embodiment of a method 400 according to the present invention for cleaning the electrical assembly contained within the arrangement 100. In step 410, a sample fluid (e.g., beer, milk, etc.) is removed from the enclosure 110. In step 420, the cleaning fluid 180 is dispensed from a position above the arrangement 100. For example, the cleaning fluid 180 can be dispensed from the cleaning assembly 160. Moreover, in step 430, the fluid 180 can contact or flow over substantially the entire housing 150 of the arrangement 100 in order to clean the electrical assembly without the need to remove the arrangement 100 from the wall 120.

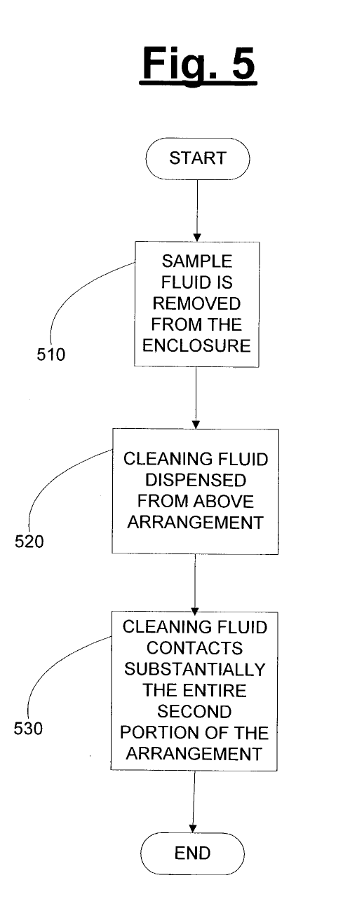

Referring to FIG. 5, a second exemplary embodiment of a method 500 according to the present invention for cleaning the electrical assembly contained within the arrangement 300 is illustrated. In step 510, the sample fluid is removed from the enclosure 110, and in step 520, the cleaning fluid 180 is dispensed from a position above the arrangement 300. As with the embodiment in FIG. 4, the cleaning fluid 180 can be dispensed from the cleaning assembly 160. Moreover, in step 530, the fluid 180 can contact or flow over substantially the entire second portion 140 of the arrangement 300 in order to clean the electrical assembly without removing the arrangement 300 from the wall 120.

While the invention has been described in connection with preferred embodiments, it will be understood by those of ordinary skill in the art that other variations and modifications of the preferred embodiments described above may be made without departing from the scope of the invention. Other embodiments will be apparent to those of ordinary skill in the art from a consideration of the specification or practice of the invention disclosed herein. It is intended that the specification and the described examples are considered as exemplary only, with the true scope and spirit of the invention indicated by the following claims.

What is claimed is:

1. An arrangement, comprising:
a first portion connected to a wall of an enclosure;
a second portion extending from the first portion; and
a housing connected to the second portion, wherein the housing is adapted to contain at least one portion of an electrical assembly, and wherein, when a fluid is dispensed from a position above the arrangement, the fluid contacts substantially the entire housing.

2. The arrangement of claim 1, wherein the housing is a sensor housing, and wherein the electrical assembly comprises at least one sensor.

3. The arrangement of claim 1, wherein the first portion has a curved shape.

4. The arrangement of claim 3, wherein the first portion has a substantially conical shape.

5. The arrangement of claim 1, wherein the second portion has a substantially cylindrical shape.

6. The arrangement of claim 1, wherein the first portion has a particular vertical plane which is substantially perpendicular to a horizontal plane of the second portion.

7. The arrangement of claim 6, wherein the horizontal plane is substantially perpendicular to a further vertical plane of the housing.

8. The arrangement of claim 7, wherein the particular vertical plane is parallel to the further vertical plane.

9. The arrangement of claim 1, wherein, when the fluid is dispensed from the position above the arrangement, the fluid contacts substantially the entire second portion.

10. The arrangement of claim 1, wherein the fluid has a first fluid portion that contacts the first portion the second portion and the housing, and wherein the fluid has a second fluid portion which only contacts the first portion and the housing.

11. An arrangement, comprising:
a first portion connected to a wall of an enclosure; and
a second portion extending from the first portion, wherein the second portion is adapted to contain at least one portion of an electrical assembly, and wherein, when a fluid is dispensed from a position above the arrangement, the fluid contacts substantially the entire second portion.

12. The arrangement of claim 11, wherein the electrical assembly comprises at least one sensor.

13. The arrangement of claim 11, wherein the first portion has a curved shape.

14. The arrangement of claim 13, wherein the first portion has a substantially conical shape.

15. The arrangement of claim 11, wherein the second portion has a substantially cylindrical shape.

16. The arrangement of claim 11, wherein the first portion has a particular vertical plane which is substantially perpendicular to a horizontal plane of the second portion.

17. The arrangement of claim 11, wherein, when the fluid is dispensed from the position above the arrangement, the fluid contacts substantially the entire first portion.

18. An arrangement, comprising:
a cleaning assembly adapted to dispense a fluid; and
a sensor assembly positioned below the cleaning assembly, wherein the sensor assembly comprises:
a first portion connected to a wall of an enclosure,
a second portion extending from the first portion, and
a housing connected to the second portion, wherein the housing is adapted to contain at least one portion of an electrical assembly, and wherein, when the cleaning assembly dispenses the fluid, the fluid contacts substantially the entire housing.

19. The arrangement of claim 18, wherein the cleaning assembly is connected to the wall of the enclosure above the sensor assembly.

20. The arrangement of claim 18, wherein the housing is a sensor housing, and wherein the electrical assembly comprises at least one sensor.

21. The arrangement of claim 18, wherein when the cleaning assembly dispenses the fluid, the fluid contacts substantially the entire second portion.

22. The arrangement of claim 18, wherein a first fluid portion contacts the first portion, the second portion, and the housing, and wherein a second fluid portion only contacts the first portion and the housing.

23. An arrangement, comprising:
a cleaning assembly adapted to dispense a fluid; and
a sensor assembly positioned below the cleaning assembly, wherein the sensor assembly comprises:
a first portion connected to a wall of an enclosure; and
a second portion extending from the first portion, wherein the second portion is adapted to contain at least one portion of an electrical assembly, and wherein, when the cleaning assembly dispenses the fluid, the fluid contacts substantially the entire second portion.

24. The arrangement of claim 23, wherein the cleaning assembly is connected to the wall of the enclosure above the sensor assembly.

25. The arrangement of claim 23, wherein the electrical assembly comprises at least one sensor.

26. The arrangement of claim 23, wherein when the cleaning assembly dispenses the fluid, the fluid contacts substantially the entire first portion.

27. A method of cleaning an arrangement, the arrangement comprising a first portion connected to a wall of an enclosure, a second portion extending from the first portion, and a housing connected to the second portion, wherein the housing is adapted to contain at least one portion of an electrical assembly, the method comprising the steps of:
removing a first fluid from the enclosure; and
dispensing a second fluid from above the arrangement, wherein the second fluid contacts substantially the entire housing.

28. The method of claim 27, wherein the housing is a sensor housing, and wherein the electrical assembly comprises at least one sensor.

29. The method of claim 27, wherein the first portion has a curved shape.

30. The method of claim 29, wherein the first portion has a substantially conical shape.

31. The method of claim 27, wherein the second portion has a substantially cylindrical shape.

32. The method of claim 27, wherein the first portion has a particular vertical plane which is substantially perpendicular to a horizontal plane of the second portion.

33. The method of claim 32, wherein the horizontal plane has a substantially perpendicular to a further vertical plane including the housing.

34. The method of claim 33, wherein the particular vertical plane is parallel to the further vertical plane.

35. The method of claim 27, wherein the second fluid contacts substantially the entire second portion.

36. The method of claim 27, wherein a first fluid portion of the second fluid contacts the first portion, the second portion and the housing, and wherein a second fluid portion of the second fluid only contacts the first portion and the housing.

37. A method of cleaning an arrangement, the arrangement comprising a first portion connected to a wall of an enclosure, and a second portion extending from the first portion, wherein the second portion is adapted to contain at least one portion of an electrical assembly, the method comprising the steps of:
removing a first fluid from the enclosure; and
dispensing a second fluid from above the arrangement, wherein the second fluid contacts substantially the entire second portion.

38. The method of claim 37, wherein the electrical assembly comprises at least one sensor.

39. The method of claim 37, wherein the first portion has a curved shape.

40. The method of claim 39, wherein the first portion has a substantially conical shape.

41. The method of claim 37, wherein the second portion has a substantially cylindrical shape.

42. The method of claim 37, wherein the first portion has a particular vertical plane which is substantially perpendicular to a horizontal plane of the second portion.

43. The method of claim 37, wherein the second fluid contacts substantially the entire first portion.
